(19) United States
(12) Patent Application Publication
(10) Pub. No.: US 2007/0209784 A1
(43) Pub. Date: Sep. 13, 2007

(54) WATER-COOLING HEAT DISSIPATION DEVICE AND WATER BLOCK FOR THE SAME

(76) Inventor: Yu-Huang Peng, Chung-Ho City (TW)

Correspondence Address: HDSL, 4331 STEVENS BATTLE LANE, FAIRFAX, VA, 22033, US

(21) Appl. No.: 11/671,577

(22) Filed: Feb. 6, 2007

(30) Foreign Application Priority Data
Mar. 10, 2006 (TW) 095203985

(51) Int. Cl. B29C 47/88; F24H 3/02

(52) U.S. Cl. 165/120

(57) ABSTRACT

A water-cooling heat dissipation device includes a water block and a pump communicated with the water block and having cooling liquid therein. The water-cooling includes a casing and a metal panel, where the casing includes a hollow and closed cavity, a water inlet and a water outlet outside the casing and communicated with the cavity. The metal panel includes a plurality of continuously-bent heat-dissipating plates, a heat-dissipating channel defined between two adjacent heat-dissipating plates, one end of the heat-dissipating plate is attached to bottom of the cavity of the casing. Therefore, the heat-dissipating plate has more contact area with the cooling liquid in a limited space to increase heat exchange effect.

### BACKGROUND OF THE INVENTION

1. Field of the Invention

The present invention relates to a water-cooling heat dissipation device and water block for the same, especially to a water-cooling heat dissipation device for electronic device and water block for the same.

2. Description of Prior Art

The air-cooling type heat dissipation device is sufficient for conventional computer because the central processing unit (CPU) of those computers is not fast. As the operation clock of present CPU exceeds 3 GHz, heat is increased with proportion to the operation clock. However, the heat dissipation device is generally constrained by the space in the chassis of computer and is difficult to improve with the pace of CPU. Moreover, the noise caused by high-speed fan is also a problem, which annoys user. Therefore, it is important issue to provide a water-cooling type and associated water block with high efficiency and low noise.

The conventional water block, such as that disclosed in Taiwan Patent No. M250533, generally comprises a heat-guiding base and a cover sealing atop the heat guiding base. Moreover, a closed cavity is defined between the heat-guiding base and the cover. A separation plate and a plurality of heat-dissipating plates extend from top of the heat-guiding base, where the separation plates and the heat-dissipating plates are arranged in the closed cavity. Two openings are defined on one side plate of the cover and the openings are communicated with external input and output pipe and are provided on opposite sides of the separation plate.

However, the prior art water block has following drawbacks. The heat-guiding base, the separation plate and the heat-dissipating plates are press-molding or extruding integrally. The molding dies have considerable cost and different molding dies are necessary for different electronic devices. Therefore, the cost for the prior art water block is difficult to reduce. Moreover, for press-molding or extruding process, the height and thickness of heat-dissipating plates and separation between the heat-dissipating plates are limited by molding die, material viscosity and mold-releasing tolerance. The heat-dissipating plates thus made have low density and small heat-dissipating area. Moreover, the heat-dissipating plate has smooth surface and cooling liquid fast flows through the heat-dissipating plate such that the cooling liquid has poor heat exchange property with the water-cooling devices.

### SUMMARY OF THE INVENTION

The present invention is to provide a water block formed by continuously bending metal plates, whereby dense heat-dissipating plates and larger heat-dissipating area can be provided within a limited space. The heat-dissipating plates have sufficient heat exchange with the cooling liquid to enhance the performance of the water block.

Accordingly, the present invention provides a water block with a casing and a metal panel. The casing comprises a hollow and closed cavity, a water inlet and a water outlet outside the casing and communicated with the cavity. The metal panel comprises a plurality of continuously-bent heat-dissipating plates, and a heat-dissipating channel is defined between two adjacent heat-dissipating plates, wherein one end of the heat-dissipating plate is attached to bottom of the cavity of the casing.

Accordingly, the present invention provides a water block with a casing and a metal panel. The casing comprises a hollow and closed cavity, a water inlet and a water outlet outside the casing and communicated with the cavity. The metal panel comprises a plurality of continuously-bent and pressed heat-dissipating plates, and a heat-dissipating channel is defined between two adjacent heat-dissipating plates, wherein one end of the heat-dissipating plate is attached to bottom of the cavity of the casing.

The present invention is to provide a water-cooling heat dissipation device having a metal panel in water block, which is formed by continuously bending. Therefore, dense heat-dissipating plates and larger heat-dissipating area can be provided within a limited space. The heat-dissipating plates have sufficient heat exchange with the cooling liquid to enhance the performance of the water block.

Accordingly, the present invention provides a water-cooling heat dissipation device, which comprises a water block and a pump communicated with the water block and having cooling liquid therein. The water-cooling comprises a casing and a metal panel, where the casing comprises a hollow and closed cavity, a water inlet and a water outlet outside the casing and communicated with the cavity. The metal panel comprises a plurality of continuously-bent heat-dissipating plates, a heat-dissipating channel is defined between two adjacent heat-dissipating plates, one end of the heat-dissipating plate attached to bottom of the cavity of the casing.

Accordingly, the present invention provides a water-cooling heat dissipation device, which comprises a water block and a pump communicated with the water block and having cooling liquid therein. The water-cooling comprises a casing and a metal panel, where the casing comprises a hollow and closed cavity, a water inlet and a water outlet outside the casing and communicated with the cavity. The metal panel comprises a plurality of continuously-bent and pressed heat-dissipating plates, a heat-dissipating channel is defined between two adjacent heat-dissipating plates, one end of the heat-dissipating plate attached to bottom of the cavity of the casing.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view showing the assembling of the water-cooling heat dissipation device of the present invention.

FIG. 2 is an exploded view showing part of the water block of the present invention.

FIG. 3 is a perspective view showing the water block of the present invention.

FIG. 4 is a perspective view showing the metal panel of the present invention.

FIG. 5 is a perspective view showing the application of the water-cooling heat dissipation device of the present invention to an electronic device.

FIG. 6 is a sectional view showing the water block of the present invention.

FIG. 7 is a perspective view showing the metal panel according to another preferred embodiment of the present invention.

FIG. 8 is a partially enlarged view of FIG. 7.

### DETAILED DESCRIPTION OF THE INVENTION

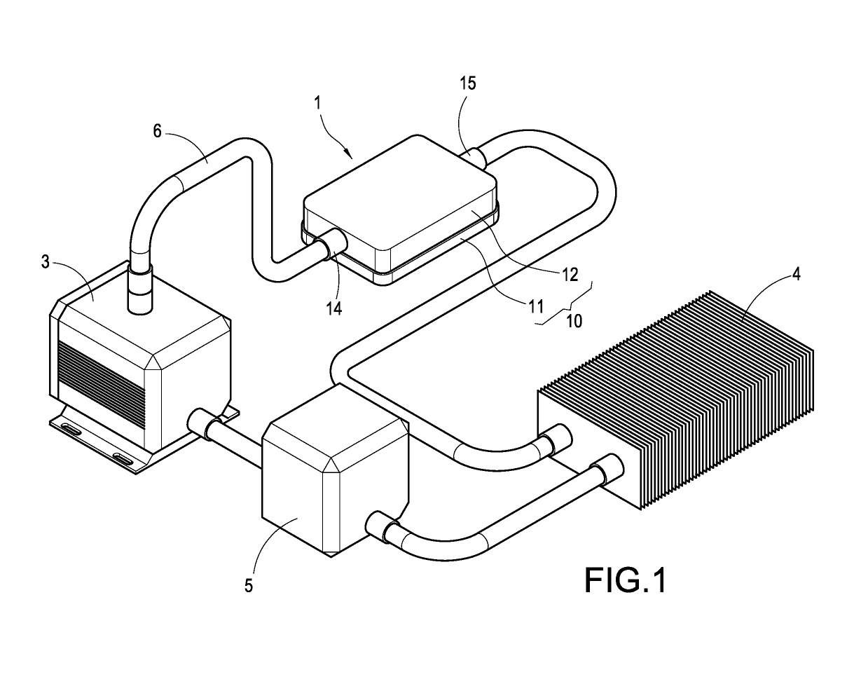

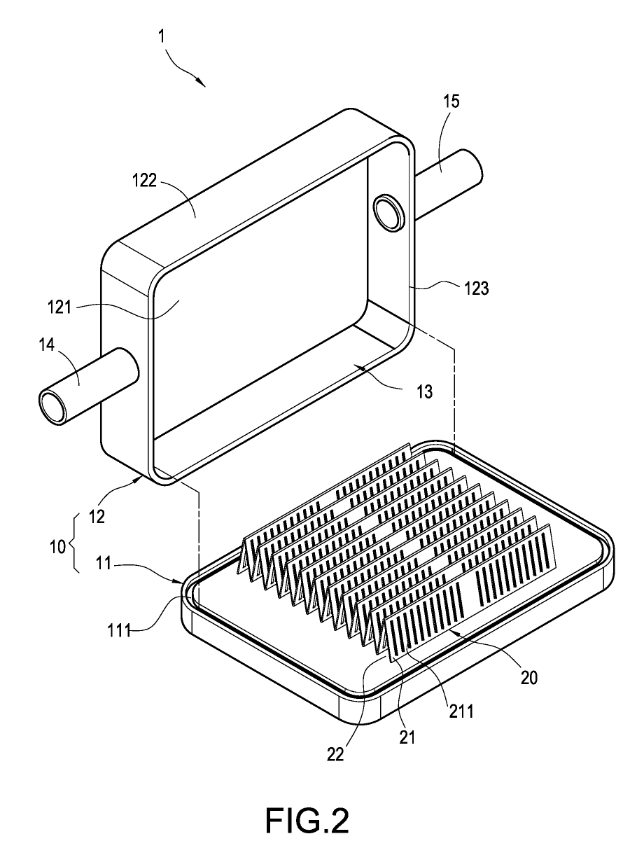

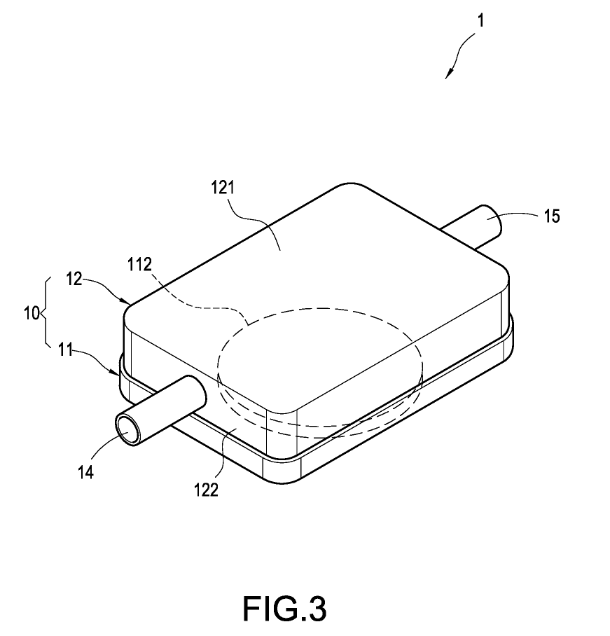

With reference to FIGS. 1 to 3, the present invention provides a water-cooling heat dissipation device and the water block thereof. The water-cooling device mainly comprises a water block 1, a pump 3, a radiator 4, a water tank 5 and a plurality of water hoses 6, where the water block 1 comprises a casing 10 and a metal panel 20.

The casing 10 comprises a heat-conducting base 11 and a cover 12 covering the top of the heat-conducting base 11. A hollow and closed cavity 13 is defined between the heat-conducting base 11 and the cover 12. The heat-conducting base 11 is made of material with good thermal conduction and comprises an annulus groove 111 at topside thereof. The heat-conducting base 11 comprises a round bump 112 downward extended from bottom thereof. The cover 12 comprises a closing plate 121 and a side plate 122 vertically extended from the closing plate 121. An opening 123 is defined at end of the side plate 122 and covers topside of the heat-conducting base 11. The end of the side plate 122 is embedded into the dent 111 of the heat-conducting base 11. The side plate 122 comprises a water inlet 14 and a water outlet 15 on topside and bottom side thereof. The water inlet 14 and the water outlet 15 are communicated with the cavity 13.

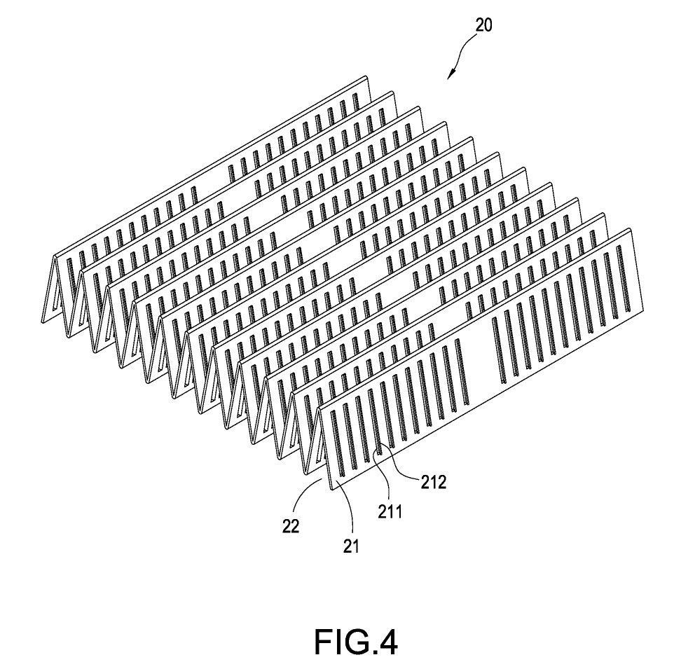

The metal panel 20 comprises a plurality of slanting continuously-bending heat-dissipating plates 21 and a heat-dissipating channel 22 is defined between two adjacent heat-dissipating plates 21. The heat-dissipating plates 21 are arranged in the cavity 13 of the casing 10 with one end attached on the heat-conducting base 11. The heat-dissipating plates 21 can be soldered to the heat-conducting base 11. As shown in FIG. 4, a plurality of slits 211 are pressed on the heat-dissipating plates 21 and the slit 211 is in the form of multi-slot. A plurality of parallel outward tabs 212 is formed on the heat-dissipating plates 21. The provision of the slits 211 and the outward tabs 212 can increase the contact area between the heat-dissipating plates 21 and the cooling liquid.

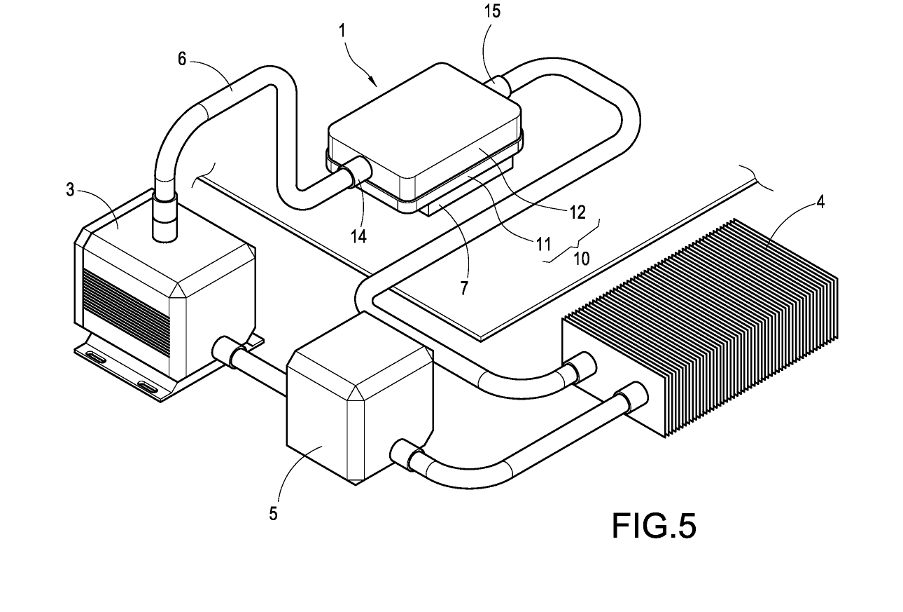

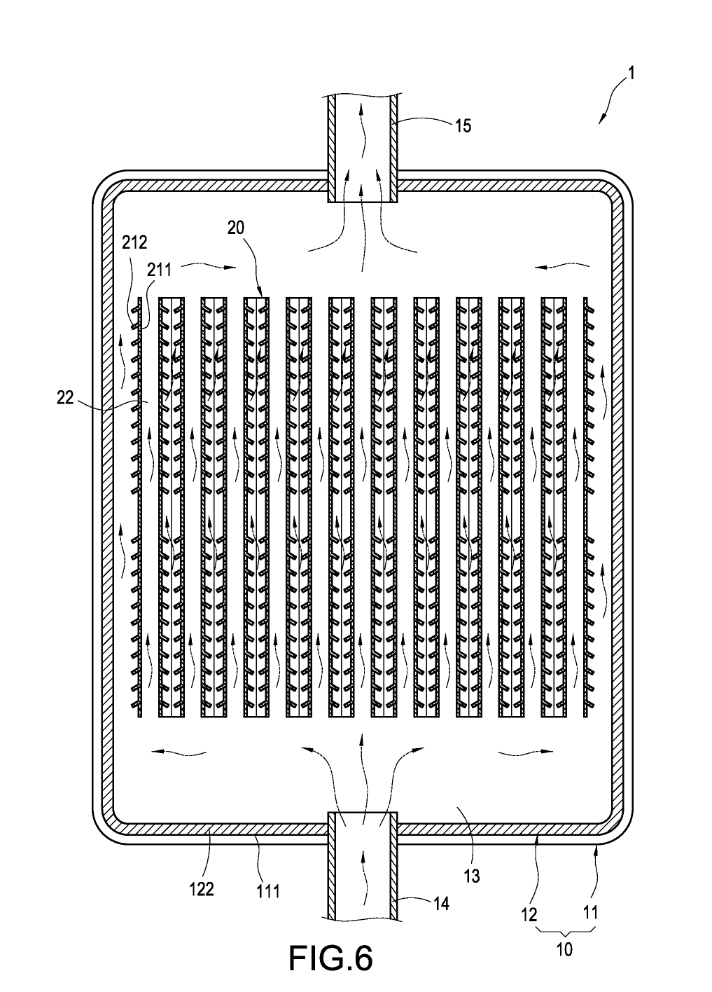

With reference to FIGS. 5 and 6, the water-cooling device of the present invention provides the dissipation function for an electronic device 7. During operation, the water inlet 14 of the water block is connected with the water outlet of the pump 3 through the water hose 6, and the water outlet 15 is connected to the inlet of the radiator 4. Afterward, the water block 1 is arranged on the electronic device 7 such as CPU. Heat conduction material (not shown) is applied to bottom of the bump 112 of the heat-conducting base 11 and then the bump 112 is attached to the topside of the electronic device 7. The heat of the electronic device 7 during operation is guided to the heat-dissipating plates 21 through the heat-conducting base 11. The cooling liquid is driven to the cavity 13 of the casing 10 through the water inlet 14 by the pump 3. The cooling liquid flows through the heat-dissipating plates 21, the heat-dissipating channel 22 and the slits 211 and the outward tab 212 of the heat-dissipating plates 21 to remove heat. The cooling liquid also has turbulent flow at back of the outward tab 212 to reduce the flowing speed of the cooling liquid through the heat-dissipating plates 21. Therefore, the cooling liquid has sufficient heat exchange with the heat-dissipating plates 21.

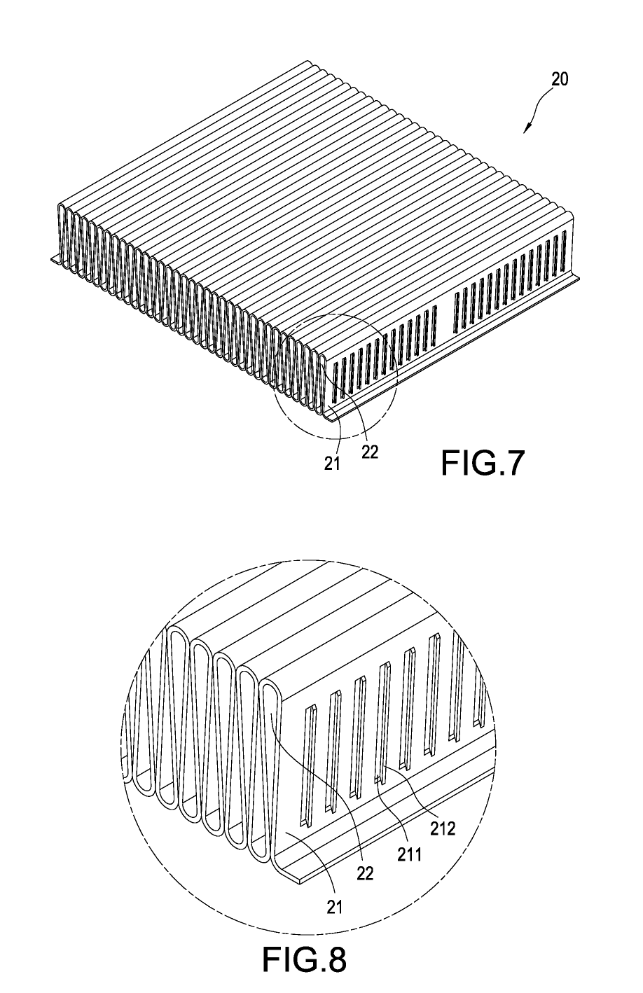

With reference to FIGS. 7 and 8, the metal panel 20 can be embodied as that shown in those figures. The metal panel 20 is first continuously bent to form a plurality of heat-dissipating plates 21 and then the heat-dissipating plates 21 are pressed such that one heat-dissipating plate 21 is in contact with one end of adjacent heat-dissipating plate 21. Therefore, the heat-dissipating plates 21 can be formed with higher density. The heat-dissipating plates 21 with higher density can be used in electronic device with larger heat generation. The cost for molding die can be saved and the development time for new product can be reduced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A water block, comprising:
a casing including a hollow and closed cavity, a water inlet and a water outlet being located outside the casing to be communicated with the cavity; and
a metal panel including a plurality of continuously-bent heat-dissipating plates, a heat-dissipating channel defined between two adjacent heat-dissipating plates, one end of the heat-dissipating plate attached to a bottom of the cavity of the casing.

2. The water block as in claim 1, wherein the casing further comprises a heat-conducting base and a cover covering the heat-conducting base, wherein the cavity is defined between the heat-conducting base and the cover.

3. The water block as in claim 2, wherein an annulus groove is defined on top of the heat-conducting base, the cover comprises a closing plate and a side plate extended outward from peripheral of the closing plate, and an end of the side plate is embedded into the annulus groove of the heat-conducting base.

4. The water block as in claim 3, wherein a bump is formed on a bottom surface of the heat-conducting base and extends outward from center of the bottom surface.

5. The water block as in claim 3, wherein the water inlet and the water outlet are connected to the side plate.

6. The water block as in claim 1, wherein a plurality of slits are defined on the heat-dissipating plates, and an outward tab is formed between slit and heat-dissipating plates.

7. The water block as in claim 1, wherein the heat-dissipating plates are formed by continuously-bending and pressing.

8. The water block as in claim 7, wherein the heat-dissipating plate is in contact with one end of adjacent heat-dissipating plate.

9. A water-cooling heat dissipation device used for heat dissipation of electronic devices and comprising a water block, a pump, a radiator, a water tank and a plurality of water hoses, wherein the water block comprises a casing and a metal panel,
wherein the casing comprises a hollow and closed cavity, and a water inlet and a water outlet is located outside the casing to be communicated with the cavity; and
wherein the metal panel comprises a plurality of continuously-bent heat-dissipating plates, a heat-dissipating channel defined between two adjacent heat-dissipating plates, one end of the heat-dissipating plate attached to bottom of the cavity of the casing.

10. The water-cooling heat dissipation device as in claim 9, wherein the casing further comprises a heat-conducting base and a cover covering the heat-conducting base, wherein the cavity is defined between the heat-conducting base and the cover.

11. The water-cooling heat dissipation device as in claim 10, wherein an annulus groove is defined on top of the heat-conducting base, the cover comprises a closing plate and a side plate extended outward from peripheral of the closing plate, and an end of the side plate is embedded into the groove of the heat-conducting base.

12. The water-cooling heat dissipation device as in claim 11, wherein a bump is formed on a bottom surface of the heat-conducting base and extends outward from center of the bottom surface.

13. The water-cooling heat dissipation device as in claim 11, wherein the water inlet and the water outlet are connected to the side plate.

14. The water-cooling heat dissipation device as in claim 9, wherein a plurality of slits are defined on the heat-dissipating plates, and an outward tab is formed between slit and heat-dissipating plates.

15. The water-cooling heat dissipation device as in claim 9, wherein the heat-dissipating plates are formed by continuously-bending and pressing.

16. The water-cooling heat dissipation device as in claim 15, wherein the heat-dissipating plate is in contact with one end of adjacent heat-dissipating plate.
